(19) United States
(12) Patent Application Publication
(10) Pub. No.: US 2015/0322995 A1
(43) Pub. Date: Nov. 12, 2015

(54) Fastener Cap Assembly

(71) Applicant: Allan Omli LLC, Winston-Salem, NC (US)

(72) Inventor: Allan T. Omli, Winston-Salem, NC (US)

(21) Appl. No.: 14/272,646

(22) Filed: May 8, 2014

(51) Int. Cl. F16B 43/00; F16B 15/00

(52) U.S. Cl. CPC F16B 43/001; F16B 15/00

(57) ABSTRACT

A fastener cap assembly for providing a plurality of fastener caps to a nailer tool that includes a plurality of fastener caps spaced from one another along a first axis extending through a center of the fastener caps, with each fastener cap having a cap width along the first axis and a cap length along a second axis orthogonal to the first axis, and with the cap length being different than the cap width. The fastener caps are releasably connected on either side to adjacent fastener caps with one or more breakable tabs, and with the breakable tabs on opposite sides of one or more fastener caps being offset from the first axis in opposite directions.

### TECHNICAL FIELD

This application relates generally to fastening systems for the construction industry, and more specifically to fastener caps that can be combined with fasteners in powered nail guns and driven onto a construction surface to provide a conformable barrier that seals around the head of the installed fastener.

### BACKGROUND

Fastener caps are often used in the construction industry to enlarge and improve the connection between an overlayment and an underlying support surface. For example, the overlayment can be plastic sheeting, an asphalt shingle, or a metallic roof panel while the underlying support surface is a roof deck panel made from plywood. The fastener caps can also be formed from a conformable material that will seal around the head of a fastener, such as a roofing nail, to prevent moisture from seeping into the aperture created by the body of the fastener and from damaging the underlying support material.

### SUMMARY

Briefly described, one embodiment of the present disclosure includes a fastener cap assembly for providing a plurality of fastener caps to a nailer tool. The fastener cap assembly includes a plurality of fastener caps spaced from one another along a first axis extending through a center of the fastener caps, with each fastener cap having a cap width along the first axis and a cap length along a second axis that is orthogonal to the first axis, and with the cap length being different than the cap width. The fastener caps are releasably connected on either side to adjacent fastener caps by at least one breakable tab, with the breakable tabs on opposite sides of one or more of the fastener caps being offset from the first axis in opposite directions.

Another embodiment of the disclosure comprises a fastener cap assembly that includes a plurality of fastener caps spaced from one another along a first axis extending through a center of the fastener caps, with each fastener cap having a cap width along the first axis and a cap length along a second axis orthogonal to the first axis, and with the cap length being greater than the cap width. Each fastener cap is releasably connected by at least one breakable tab to an adjacent fastener cap, and with the plurality of fastener caps being subdivided into sub-groups containing an equal number of fastener caps, wherein the breakable tabs between the fastener caps in each sub-group are offset to the same side of the first axis and the breakable tabs on either side of each sub-group are offset from the first axis in opposite directions.

Yet another embodiment of the disclosure includes a fastener cap assembly for providing a plurality of fastener caps to a nailer tool, the assembly comprising a plurality of fastener caps spaced from one another along a first axis extending through a center of the fastener caps, each fastener cap having a cap width along the first axis and a cap length along a second axis orthogonal to the first axis, and with the cap length being different than the cap width to form a fastener cap with an oblong shape. The fastener caps are releasably connected on either side to adjacent fastener caps by at least one breakable tab.

The invention will be better understood upon review of the detailed description set forth below taken in conjunction with the accompanying drawing figures, which are briefly described as follows.

### BRIEF DESCRIPTION OF THE DRAWINGS

FIG. 1 is a side view of a nailer tool for driving fasteners into a construction surface, as found in the prior art;

FIG. 2 is a plan view of a portion of a fastener cap assembly, in accordance with one representative embodiment of the present disclosure.

FIGS. 3A-3C are plan, side and bottom views, respectively, of one of the fastener caps in the fastener cap assembly of FIG. 2.

FIGS. 4A-4B are cross sectional side views of the fastener caps in the fastener cap assembly of FIG. 2 after installation to a construction surface with a nail or with a staple, respectively.

FIG. 5 is a perspective view of a fastener cap assembly in a rolled configuration, in accordance with another representative embodiment of the present disclosure.

FIG. 6 is a plan view of a portion of a fastener cap assembly, in accordance with another representative embodiment of the present disclosure.

Those skilled in the art will appreciate and understand that, according to common practice, various features of the drawings discussed below are not necessarily drawn to scale, and that dimensions of the various features and elements of the drawings may be expanded or reduced to more clearly illustrate the embodiments of the present disclosure described herein.

### DETAILED DESCRIPTION

Generally described, the present disclosure relates to a fastener cap assembly for providing a plurality of fastener caps to a nailer tool that finds common usage in the construction industry. As discussed below, the fastener cap assembly can provide significant advantages and benefits over other fastener cap assemblies and methods for providing fastener caps to nailer tools. However, the recited advantages are not meant to be limiting in any way, as one skilled in the art will appreciate that other advantages may also be realized upon practicing the present disclosure. It is also to be appreciated that the fastener cap assembly may not be limited only to uses relating to the construction industry, and that other uses and applications are possible and may also be considered to fall within the scope of the present disclosure.

Furthermore, it is also to be understood that the fastener cap assembly of the present disclosure is not limited to the specific devices, methods, conditions, or parameters of the representative embodiments described and/or shown herein, and that the specific terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

Referring now in more detail to the drawing figures, wherein like parts are identified with like reference numerals throughout the several views, FIG. 1 illustrates a fastener driver, or nailer tool 10, for driving fasteners into the material 82 of a construction surface 80, as may be found in the prior art. The nailer tool 10 generally includes a support plate 12 that contacts the construction surface 80, a handle 16 for the handling and manipulation of the nailer tool by a user, a driver mechanism 20 with a piston 22 that is generally aligned perpendicular to the support plate 12, and a magazine 30 for holding and feeding a supply of fasteners 70 into the driver mechanism 20. Upon actuation with a trigger 18, the piston 22 of the driver mechanism 20 is configured to collect a fastener 70 from the magazine and to drive the fastener 70 through a nose piece 24 and into the material 82 of the construction surface 80 that can generally comprise a plywood roof deck, asphalt shingles, plastic sheeting, metallic roofing panels, and the like. In some aspects, the nailer tool 10 can be externally powered, such as with automatic pneumatic, electric, or powder-actuated nail guns, in which the driver mechanism 20 is operable to automatically drive nails or staples into the material 82 of the construction surface 80. In other aspects, the nailer tool can be manually driven by impact with a work surface or other manual action, e.g. with a “slap hammer” or squeeze stapler.

The powered nailer tool 10 can also include a cap container 40 for holding a coiled fastener cap assembly 50 comprising a plurality of fastener caps 52 aligned in a row and held together by breakable tabs. A cap indexing mechanism 44 for guiding and advancing the free end of the fastener cap assembly 50 toward the nose piece 24 is also operated by the driver mechanism 20, whether externally or manually powered.

The cap indexing mechanism 44 and nose piece 24 are generally configured to align a fastener cap 52 below the fastener 70 that is about to be installed. Operation of the driver mechanism 20 causes the narrow body portion of the fastener 70 to pierce and pass through the fastener cap 52 before entering the material 82 of the construction surface 80, and with the expanded head portion of the fastener 70 engaging the fastener cap 52 to pull the fastener cap down and out from the nose piece, and in the process breaking the tab that connects the fastener cap 52 to the next fastener cap in the fastener cap assembly 50.

A description of a powered fastener driver or nailer tool and fastener cap assemblies similar to those described above can be found in U.S. Pat. No. 6,145,725, filed on Mar. 10, 1999, and entitled “Fastener Driver Cap Feeder Assembly,” and which patent is incorporated by reference in its entirety herein. In addition, a description of a manually actuated fastener driver or nailer tool can be found in U.S. Pat. No. 7,232,050 filed on Feb. 21, 2005, and entitled “Manually Actuated Fastener Driver with Fastener Cap Reservoir and Advancement Mechanism,” and which patent is incorporated by reference in its entirety herein.

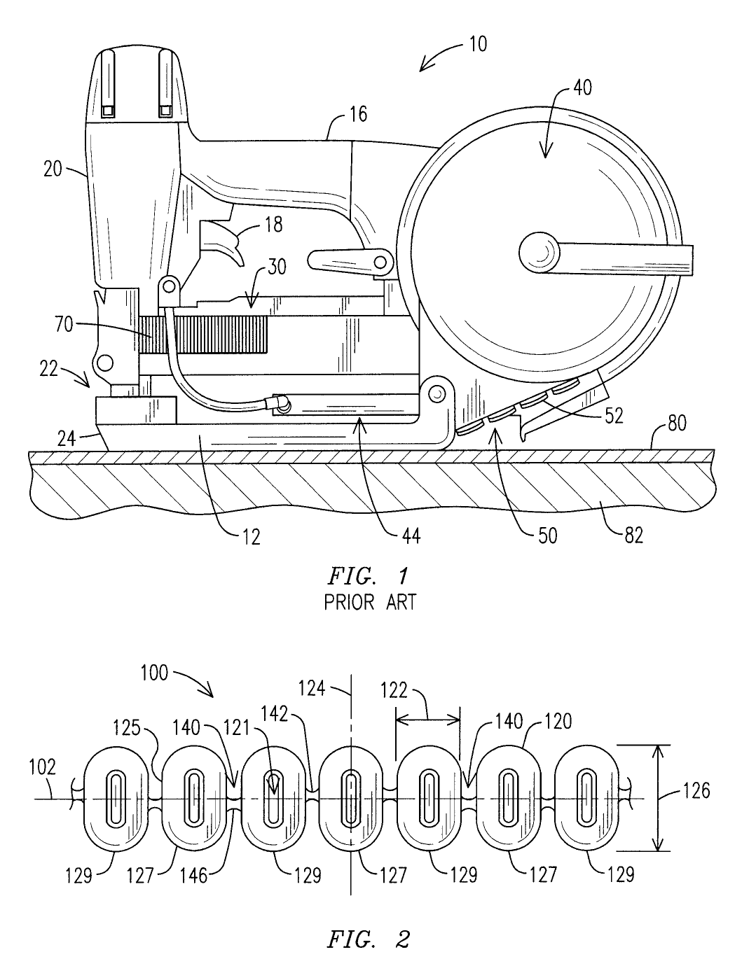

FIG. 2 is a plan view of a portion of a fastener cap assembly 100 for providing a plurality of fastener caps to a nailer tool, in accordance with one representative embodiment of the present disclosure. The fastener cap assembly 100 generally comprises a plurality of fastener caps 120 that are spaced from one another along a first or centerline axis 102 that extends through the center portions 121 of the fastener caps 120. Each fastener cap 120 can have a cap width 122 along the first axis as well as a cap length 126 along a second axis 124 that is orthogonal or perpendicular to the first axis 102. In addition, the cap length 126 can be different than the cap width 122 to form a fastener cap having an oblong shape. In the embodiment of the fastener cap assembly 100 shown in FIG. 2, for instance, the cap length 126 can be greater than the cap width 122, so that the second or long axes 124 of the oblong fastener caps 120 are perpendicular to the first or centerline axis 102 of the fastener cap assembly 100. It will be appreciated that this aspect can be useful for increasing the number of fastener caps 120 in any predetermined length of the fastener cap assembly 100 over other fastener cap assemblies of equal length that may be found in the prior art.

In one aspect the cap length 126 can be at least one and a half times the cap width 122, as shown in FIG. 2. Nevertheless, other configurations and arrangements, such as with the long axes of the oblong fastener caps being parallel to the first or centerline axis of the fastener cap assembly, are also contemplated and considered to fall within the scope of the present disclosure.

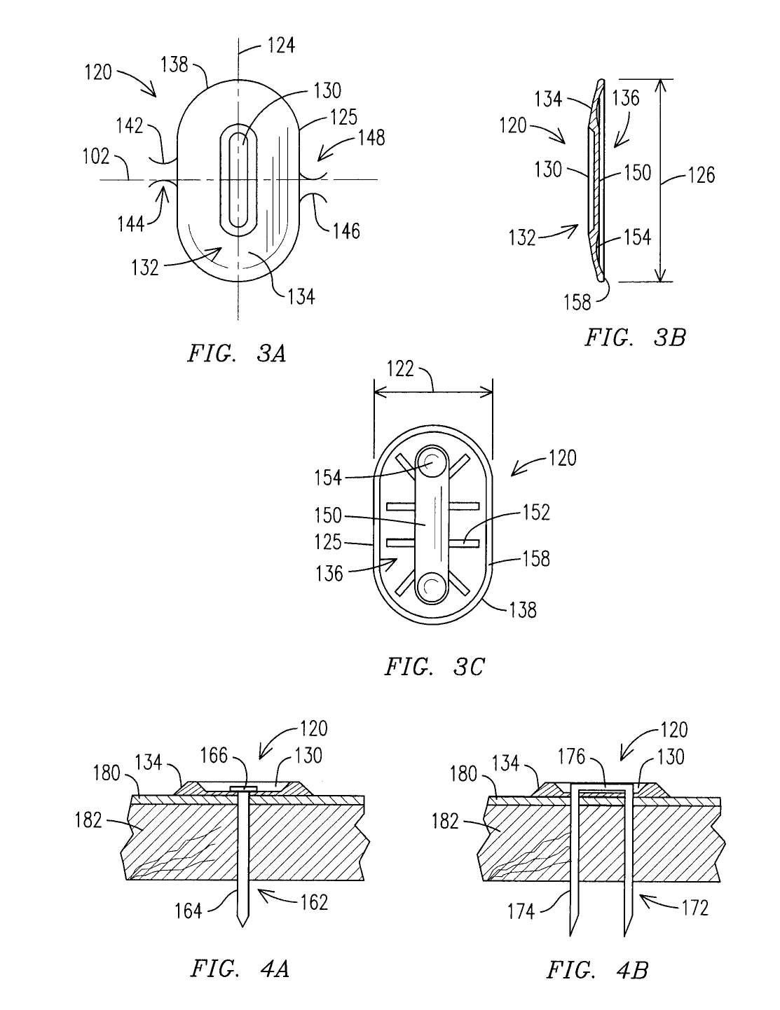

Each fastener cap 120 is releasably connected by at least one breakable tab 140 to an adjacent fastener cap. In one aspect shown in FIG. 2, the breakable tabs on either side of at least every other fastener cap 120 are offset from the first axis 102 in opposite directions. For example, breakable tabs 142 can be located above the first axis 102 while breakable tabs 146 are located below the first axis 102, with every other fastener cap 129 being connected by both breakable tabs 142, 146. With reference to FIGS. 2 and 3A, in another aspect both the upper sides 148 of one set of breakable tabs 146 and the lower sides 144 of the other set of breakable tabs 142 can be aligned with the first axis 102. If the upper sides 148 and lower sides 144 of the breakable tabs are curved, the apex portion of the curves can substantially align with the first axis 102.

The fastener cap assembly 100 of alternating fastener caps 120 and breakable tabs 140 can generally be made from the same material, such as a conformable plastic or thermoplastic such as HDPE (High-Density Polyethylene), and may be manufactured in a high-volume production process such as injection molding.

In yet another aspect of the fastener cap assembly 100, the plurality of fastener caps 120 can be subdivided into sub-groups containing an equal number of fastener caps, with the breakable tabs 140 between the fastener caps with in each sub-group being offset to the same side of the first axis while the breakable tabs on either side of each sub-group are offset from the first axis in opposite directions, and in alternating fashion. When the number of faster caps in each sub-groups is two, as illustrated in FIG. 2, each sub-group has one breakable tab between the two faster caps 127, 129 that is offset to one side of the fastener caps, while the fastener caps between the sub-groups are offset from the first axis in opposite directions and in alternating fashion. The skilled artisan would also understand how the pattern is repeatable with fastener cap assemblies having three or more fastener caps in each sub-group.

In another aspect of the fastener cap assembly 100 shown in FIGS. 2 and 3A-3C, the sides 125 of each fastener cap can be straight and parallel to the second axis 124 and the breakable tabs 140 can extend between adjacent parallel sides 125 of adjacent fastener caps. As stated above, providing the oblong fastener caps 120 with straight sides 125 and a second or long axis 124 aligned perpendicular to the first or centerline axis 102 of the fastener cap assembly 100 can allow for more fastener caps 120 to be included in a fixed length of fastener cap assembly 100 than for fastener caps having other shapes.

As further illustrated in FIGS. 3A & 3B, each fastener cap 120 can include an elongate groove or depression 130 that is formed into the top surface 132 and aligned with the second axis 124 of each fastener cap 120, and that is sized to receive the head 166 of a nail 162 (FIG. 4A) or the crown 176 of a staple 172 (FIG. 4B). In one aspect, the portion of the top surface 132 between the elongate depression 130 and the perimeter edge 138 of the fastener cap 120 can comprise a sloped ramp surface 134 that provides the fastener cap 120 with a low profile or minimal aspect ratio. The shorter profile can limit the amount of moisture that can pool against the perimeter edge 138, as well as reduce the visibility of the individual fastener caps 120 after installation, which can also be an important consideration on high visibility roofing surfaces.

On the bottom surface 136 of the fastener caps 120 shown in FIG. 3C, the underside 150 of the elongate depression can be elevated above a bottom rim surface 158 that follows the perimeter edge 128, with support ribs 152 extending at least partially across the gap between the two features. This configuration can cause the sloped ramp surface 134 to flex downward upon installation so that the fastener cap 120 becomes compressed between the head of the fastener and the construction surface 180 during installation. When combined with the conformable plastic material of the fastener cap 120, this compression can provide a tight seal around the head of the fastener that prevents the ingress of moisture around the body of the fastener. In one aspect, small cups or reliefs 154 can also be formed into either end of the underside 150 of the elongate depression to reduce the thickness of the fastener cap 120 in these locations, making it easier for the teeth and legs of a staple to penetrate through the fastener cap during installation.

Further illustrated in FIGS. 4A and 4B, the elongate depression 130 can be sized to receive either the head end 166 of a nail 162 or the crown 176 of a staple 172, respectively, so that the head 162 or crown 172 of the fasteners do not extend above the top edge of the fastener cap 120. As shown in FIG. 4A, the body 164 of the nail 162 can press through the center of the fastener cap 120 and into the material 182 of the construction surface, with the head 166 pulling the elongate depression downward and bending the sloped ramp surface 134 until the underside 150 of the elongate depression abuts against the construction surface 180. As shown in FIG. 4B, the legs 174 of the staple 172 can press through the end portions of the elongate depression 130 and into the material 182 of the construction surface 180 to wedge the fastener cap 120 tight between the staple 172 and the construction surface 180.

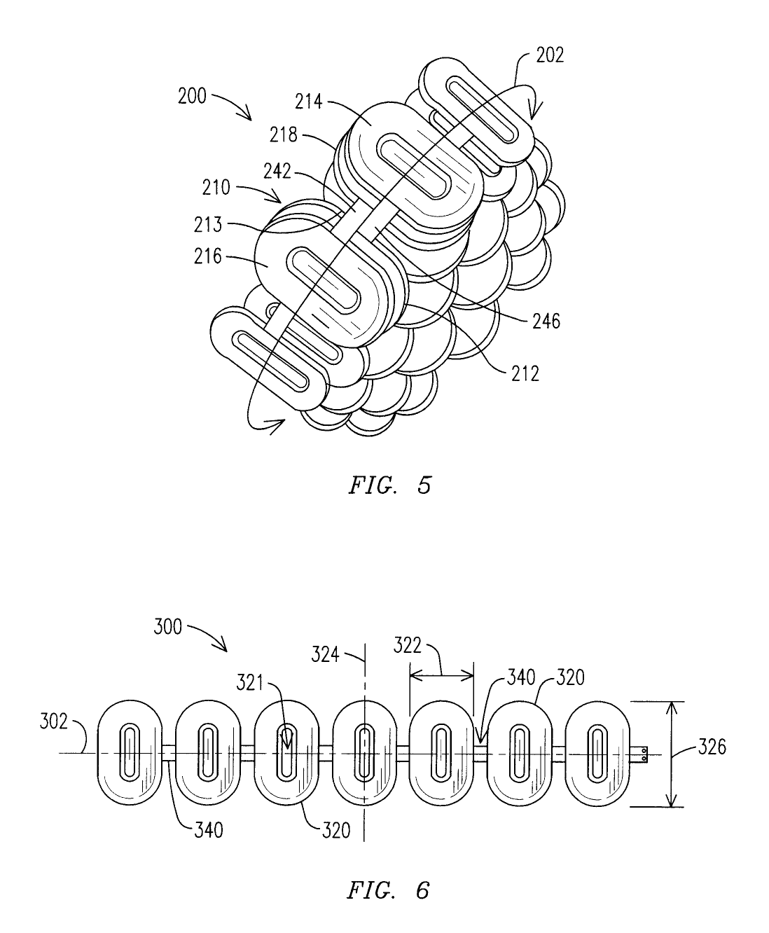

Another aspect of the present disclosure is shown in FIG. 5, in which a length of fastener cap assembly 200 has been rolled up into a circular or rolled configuration. In this arrangement, the last fastener cap 212 at the free end 210 of the fastener cap assembly 200 can be slipped underneath a fastener cap 216 in the next lowest coil, while the next-to-last fastener cap 214 remains on top the fastener cap 218 just below it. This causes breakable tab 246 joining the last two fastener caps 212, 214 to cross against breakable tab 242 that joins the two fastener caps 216, 218 immediately below the free end 210 of the rolled fastener cap assembly 200. The adjacent sides of the breakable tabs 242, 246 can slide against each other, thereby allowing the trailing straight side edge 213 of the last fastener cap 212 to become bound and locked underneath the bottom of breakable tab 242. Moreover, with the two breakable tabs 242, 246 being offset in opposite directions from the first axis 202 of the fastener cap assembly 200, the first axis 202 can substantially align with itself along each inward coil and to spiral inward toward the center of the roll along one center plane. In addition, the rounded ends of the oblong fastener caps 220 also substantially align together along opposite outer planes, so that the fastener cap assembly 200 becomes coiled and locked together into a hockey puck-shaped body, as shown in FIG. 5. This feature can facilitate storage of the fastener cap assembly 200 prior to use as well as installation of the fastener cap assembly 200 into the cylindrical cap container 40 shown in FIG. 1. The chance of undesired “unrolling” and subsequent tangling is reduced by this aspect of the invention.

In another embodiment of the disclosure shown generally in FIG. 6, the fastener cap assembly 300 can comprise a plurality of fastener caps 320 that are spaced from one another along a first axis 302 that extends through the center portions 321 of the fastener caps 320. Similar to the embodiment illustrated in FIG. 2 above, each fastener cap 320 can have a cap width 322 along the first axis and a cap length 326 along a second axis 324 that is different than the cap width 322, so as to provide the fastener caps 320 with an oblong shape. In this embodiment, however, each of the fastener caps 320 may be releasably connected to one or more adjacent fastener caps with breakable tabs 340 that are substantially centered along the first axis 302. This aspect can be useful for maintaining the centerline strength of the fastener cap assembly 300 while increasing the number of fastener caps 320 in each predetermined length of the assembly.

In summary, the fastener cap assembly of the present disclosure has been described in terms of preferred embodiments and methodologies considered by the inventors to represent the best mode of carrying out the invention. However, a wide variety of additions, deletions, and modification might well be made to the illustrated embodiments by skilled artisans within the scope of the invention. For instance, the fastener cap assembly can be made from a hard yet resilient or conformable material other than plastic or HDPE. These and other revisions might be made by those of skill in the art without departing from the spirit and scope of the invention, which is constrained only by the following claims.

What is claimed is:

1. An assembly for providing a plurality of fastener caps to a nailer tool, the assembly comprising:
a plurality of fastener caps spaced from one another along a first axis extending through a center of the fastener caps, each fastener cap having a cap width along the first axis and a cap length along a second axis orthogonal to the first axis, the cap length being different than the cap width, the fastener caps being releasably connected on either side to adjacent fastener caps by at least one breakable tab,
wherein the breakable tabs on either side of at least one of the fastener caps are offset from the first axis in opposite directions.

2. The assembly of claim 1, wherein an upper side of one of the breakable tabs and a lower side of the other of the breakable tabs are aligned with the first axis.

3. The assembly of claim 1, wherein the breakable tabs on either side of at least every other fastener cap are offset from the first axis in opposite directions.

4. The assembly of claim 1, further comprising the plurality of fastener caps being subdivided into sub-groups containing an equal number of fastener caps, wherein the breakable tabs between the fastener caps in each sub-group are offset to the same side of the first axis and the breakable tabs on either side of each sub-group are offset from the first axis in opposite directions and in alternating fashion.

5. The assembly of claim 4, wherein the equal number of fastener caps in each subgroup is at least two.

6. The assembly of claim 1, wherein the sides of the fastener caps are straight and parallel to the second axis and the breakable tabs extend between adjacent parallel sides of adjacent fastener caps.

7. The assembly of claim 1, wherein a breakable tab proximate an outer end of the assembly is adapted to interlock with another breakable tab along the length of the assembly when the assembly is rolled into a circular configuration.

8. The assembly of claim 1, wherein the cap length is greater than the cap width.

9. The assembly of claim 8, wherein the cap length is at least one and a half times the cap width.

10. The assembly of claim 9, further comprising an elongate depression formed into the top surface and aligned with the second axis of each fastener cap.

11. The assembly of claim 10, wherein a length of the elongate depression is sufficient to receive the head end of a staple.

12. A fastener cap assembly for providing a plurality of fastener caps to a nailer tool, the fastener cap assembly comprising:
a plurality of fastener caps spaced from one another along a first axis extending through a center of the fastener caps, each fastener cap having a cap width along the first axis and a cap length along a second axis orthogonal to the first axis, the cap length being greater than the cap width;
each fastener cap being releasably connected by at least one breakable tab to an adjacent fastener cap; and
the plurality of fastener caps being subdivided into sub-groups containing an equal number of fastener caps,
wherein the breakable tabs between the fastener caps in each sub-group are offset to the same side of the first axis and the breakable tabs on either side of each sub-group are offset from the first axis in opposite directions.

13. The fastener cap assembly of claim 12, wherein the equal number of fastener caps in each subgroup is at least two.

14. The fastener cap assembly of claim 12, wherein the sides of the fastener caps are straight and parallel to the second axis and the breakable tabs extend between adjacent parallel sides of adjacent fastener caps.

15. The fastener cap assembly of claim 12, wherein a top side of the breakable tab on one side of a sub-group and a bottom side of the breakable tab on the other side of the sub-group are aligned with the first axis.

16. The fastener cap assembly of claim 12, wherein a breakable tab proximate an outer end of the assembly is adapted to interlock with another breakable tab along the length of the assembly when the assembly is rolled into a circular configuration.

17. The fastener cap assembly of claim 12, wherein the cap length is at least one and a half times the cap width.

18. The fastener cap assembly of claim 12, further comprising an elongate depression formed into the top surface and aligned with the second axis of each fastener cap.

19. The fastener cap assembly of claim 18, wherein a length of the elongate depression is sufficient to receive the head end of a staple.

20. An assembly for providing a plurality of fastener caps to a nailer tool, the assembly comprising a plurality of fastener caps spaced from one another along a first axis extending through a center of the fastener caps, each fastener cap having a cap width along the first axis and a cap length along a second axis orthogonal to the first axis, the cap length being different than the cap width, and wherein the fastener caps are releasably connected on either side to adjacent fastener caps by at least one breakable tab.

21. The assembly of claim 20, wherein the cap length is greater than the cap width.

22. The assembly of claim 20, wherein the breakable tabs on either side of at least one of the fastener caps are offset from the first axis in opposite directions.
